(19) United States
(12) Patent Application Publication
(10) Pub. No.: US 2012/0189893 A1
(43) Pub. Date: Jul. 26, 2012

(54) TEMPERATURE-CONTROLLED BATTERY SYSTEM

(75) Inventors: Walter Lachenmeier, Sankt Augustin (DE); Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/145,196

(22) PCT Filed: Jan. 19, 2010
(86) PCT No.: PCT/EP2010/000286

§ 371 Date: Feb. 15, 2012

(30) Foreign Application Priority Data
Jan. 23, 2009 (DE) 10 2009 005 852.4

(51) Int. Cl. H01M 10/50

(52) U.S. Cl. 429/120

(57) ABSTRACT

The present invention relates to a battery system, in particular for a motor vehicle, comprising at least one battery. To improve the electrical efficiency it is disclosed, that at least one absorption cooling device is included, which provides a useable controlled cooling for the cooling of at least one battery.

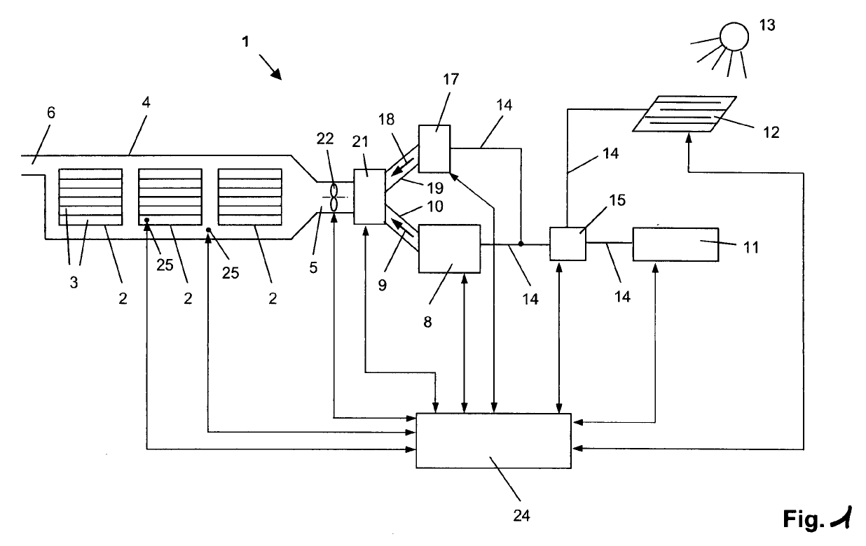

Priority application DE 10 2009 005 852 as filed on Jan. 23, 2009 is fully incorporated by reference herein.

The invention relates to a battery system having at least one battery, according to claim 1. The invention is described in the context of lithium-ion batteries. It is noted that the invention can also be applied to other batteries, regardless of the chemistry, or also for rechargeable batteries.

Batteries, in particular lithium-ion batteries, are known from the prior art as environmentally friendly energy storage devices having particularly high power. As so-called “large format batteries”, they are particularly useful for energy storage in modern electric and hybrid vehicles. In addition, stationary battery systems are known, for example, as emergency power supply of buildings.

As a result of charging and discharging processes, heat generation occurs within batteries, from which the generated heat needs to be conducted away, to prevent heat accumulation and to maintain an optimum operating temperature for the electrical efficiency of the battery. On the other hand, at low temperatures, it may be advantageous to increase the operating temperature of a battery in order to improve electrical efficiency. Electrical efficiency can be measured, e.g., by means of the efficiency factor, the electrical capacity, or a temporary power generation/output. Operating a battery within the range of its optimum operating temperature also extends its lifespan.

One objective of the invention is to provide means to extend the lifespan of batteries.

This objective is achieved by a battery system with the features of claim 1. The features of the depending claims relate to advantageous and preferred embodiments.

According to the invention, a battery system is provided, including at least one battery, wherein at least one absorption cooling device is also included, which provides_useable controlled cooling (“Klimakälte”) for the cooling of at least one battery. The battery system according to the invention is particularly, but not exclusively, intended for a motor vehicle.

Due to the cooling by the absorption cooling device, the lifespan of a battery, or of a plurality of batteries, can be extended.

As generally known from the prior art, a battery can be formed from a single cell or from a plurality of, e.g., stacked, cells. Furthermore, according to the invention, a set of batteries can also be provided. The battery also comprises an electrolyte. This electrolyte can include lithium-ions.

An absorption cooling device is a cooling device, the operating principle of which is generally known from the prior art. In a closed system, a refrigerant is evaporated within a low pressure area. Thereby, useable controlled cooling is generated. The generated refrigerant vapor is absorbed or dissolved by an absorber (absorbent agent), usually associated with heat emission. This is also referred to as the “absorption process”. The absorber, enriched with the refrigerant, is subsequently pumped into a high pressure area, where separation of the refrigerant and the absorber occurs, while heat is being supplied, the so-called “driving heat”. This is also called a “desorption process”. Subsequently, a condensation and a liquefaction of the refrigerant occurs by means of heat extraction and re-evaporation. The useable controlled cooling can be conducted away by means of a heat exchanger.

An absorption cooling device has the advantageous feature that the energy demand is low and the cooling supply is effective. Thereby, the electrical efficiency of a battery system, and in particular, the efficiency factor, can be improved significantly.

According to a preferred embodiment, water is provided as a refrigerant for the absorption cooling device. Water is advantageous in that it is a particularly environmentally friendly refrigerant.

According to a preferred embodiment, an ionic fluid is provided as absorber (or, respectively, as absorbent agent) for the absorption cooling device. Therein, the absorption cooling device could also be referred to as an “ionic fluid cooling device”. Ionic fluids have the advantage that they are soluble in water to an almost unlimited amount, or vice versa, and that they have only little corrosive effect. Ionic fluids additionally have, the advantage, that they typically, can be completely regenerated within the process. Ionic fluids are, in particular, liquid salts, which are, preferably, not solid at room temperature. These liquid salts advantageously have a good heat storage capacity and are usually neither toxic nor harmful to the environment.

According to a preferred embodiment, at least one latent heat storage device is included as a heat source, which provides a driving heat for the absorption cooling device. A latent heat storage is a device, which is capable of storing thermal energy with minimum loss and over many repeated cycles and over a long period of time. Latent heat storage devices are available on the market, in particular for the automotive sector, in particular as ready-to-use components, in different versions.

A heat source, which provides the driving heat for the absorption cooling device is in thermal contact with the absorption cooling device. Such a thermal contact can, for example, be a closed system for a heating medium, which includes, in particular, a tubing system.

According to a preferred embodiment, at least one component, which is exposed to an external energy source, is included as a heat source, which provides the driving heat for the absorption cooling device. This component is preferably a photovoltaic system. By means of such a photovoltaic system, the energy of a sun-exposed car roof can, for example, be used to provide the driving heat for the absorption cooling device.

According to a preferred embodiment, the heat of at least one battery, which is operated in a highly dynamic manner or which is constantly operated, can also be used as the driving heat for the absorption cooling device, which, preferably, is likewise cooled, due to the fact that heat is being extracted. Preferably, said battery is not cooled by the absorption cooling device.

According to a preferred embodiment, a plurality of heat sources is included, each providing or being able to provide driving heat for the absorption cooling device, wherein a thermal connection between the absorption cooling device and at least one of these components is capable of being interrupted, i.e. separable and reconnectable, by means of at least one valve. This allows, depending on the situation, the access to different heat sources. Individual heat sources can be connected or disconnected depending on the situation, by means of a valve. Preferably, the valve is a directional valve (“Wegeventil”) or a control valve.

According to a preferred embodiment, at least one temperature controlled channel is included, in which useable controlled cooling of the absorption cooling device is introduced as a cold air flow. A temperature controlled channel can, for example, also be formed by means of a tubing system, which surrounds the battery. Alternatively, heat conductive metal plates or sheets can be provided for thermally contacting the battery with the temperature controlled channel. The temperature controlled channel comprises at least one inlet for the air flow. The temperature controlled channel comprises at least one outlet from which the air flow can (re)exit.

According to a preferred embodiment, at least one heat exchanger is included, which provides, or can provide useable heat to warm up the battery. Thereby, a warming up of the battery is also possible, whereby the electrical efficiency of the battery system according to the invention, can be further improved. In particular, a comprehensive temperature control (thermostatisation) of the battery is possible.

According to a preferred embodiment, provisions are made, so that said heat exchanger is thermally connected or, respectively, in thermal contact with at least one heat source, which provides driving heat for the absorption cooling device. Thereby the heat of a heat source can be used both to drive the absorption cooling device, and thus, to cool the battery, as well as to warm up the battery. For this, the respective heat source is in thermal contact with both the absorption cooling device and with the respective heat exchanger, e.g. by means of a tubing system. Thermal contact can preferably be established and/or interrupted by means of at least one valve.

According to a preferred embodiment, provisions are made that the useable heat for warming up the battery can be introduced as a warm air flow into the temperature controlled channel. With respect to the temperature controlled channel, reference is made to the above embodiment.

According to a preferred embodiment, provisions are made that at least one valve is included to introduce, or to be able to introduce, selectively, a warm air flow or a cold air flow into the temperature controlled channel. Preferably, the possibility is provided to switch between warming or cooling the battery by means of said valve.

According to a preferred embodiment provisions are made, that at least one blowing unit is included to drive a warm or a cold air flow through the temperature controlled channel. Preferably, said blowing unit is arranged near the inlet of the temperature controlled channel.

According to a preferred embodiment at least one control unit is included, which allows a predectice control and/or a adjusting of the temperature of the battery. The predictive control is based on a prediction of future system behavior. Ideally, control occurs by means of rewritable instructions, which regulate the conditioning of the battery system according to the needs of the methods of operation and/or of any potential degree of deterioration. The control is preferably software-based. Preferably, the control unit is connected to at least one relevant component, and particularly preferably, connected to a variety of relevant components, through which the temperature of the battery can be influenced. This can include, for example, the control and/or the adjusting of the above mentioned valves or blowing unit. Preferably, this control unit can also control and/or adjust the charging status of the battery.

The invention is further illustrated below by a single FIGURE. The FIGURE shows, in a schematic view, an embodiment of the lithium-ion battery system according to the invention.

The lithium-ion battery system is referenced to as 1. Said system comprises several lithium-ion batteries 2, which are each made up of individual cells 3. The lithium-ion batteries 2 are arranged in a temperature controlled channel 4, which here, only as an example, completely encloses the lithium-ion batteries 2. The temperature controlled channel has an inlet 5 and an outlet 6.

The lithium-ion battery system 1 further includes an absorption cooling device 8, which provides useable controlled cooling. The operating principle of an absorption cooling device has already been explained above. The essential advantages of an absorption cooling device can be seen as providing low energy and effective cooling supply. The transmission of cooling occurs by means of a cold air flow 9, which is introduced into the temperature controlled channel 4 by means of a nozzle 10 and an inlet 5, and serves therein, to cool lithium-ion batteries 2.

In the illustrated embodiment, the driving heat for the absorption cooling device 8 is provided by two heat sources. The first heat source is a latent heat storage device 11 and the second heat source is a photovoltaic system 12, which is exposed to a an external energy source, namely to solar radiation 13. This photovoltaic system can, for example, be provided on the roof of a motor vehicle. Alternatively, only one or more than two heat sources can be provided. Heat sources 11 and 12 are thermally contacted with absorption cooling device 8 by means of a closed system comprising a heating medium. The heating medium system includes a tubing system 14 with supply and return lines.

Thermal contact between heat sources 11 and 12 and the absorption cooling device 8 can be controlled depending on the situation by means of a valve 15, i.e. may be connected and/or interrupted. Valve 15 is preferably, a directional valve or a control valve. Instead of one valve, also several valves may be provided, which, for example, may connect or interrupt supply and return to the respective heat source.

Lithium-ion battery system 1 also includes a heat exchanger 17, which may provide useable heat to warm up the lithium-ion batteries 2. For this, said heat exchanger 17 is thermally connected with the heating medium system or, respectively, its tubing system 14. The heat from the heat sources 11 and 12 can therefore, also be used to provide a warm air flow 18. The warm air flow 18 is passed through a nozzle 19 and an inlet 5 into the temperature controlled channel 4, and serves there to warm up lithium-ion batteries 2.

A valve 21 is used for selectively introducing a cold air flow 9 or a warm air flow 18 into the temperature controlled channel 4. Valve 21 can also be configured as a flap or the like. This allows a switching between warming and cooling the lithium-ion batteries 2, which makes it possible to operate the lithium-ion batteries 2 depending on the situation at all times and under different environmental conditions within the range of thus respective optimum operating temperature, which improves the electrical efficiency and increases the lifespan of the lithium-ion batteries 2.

In order to allow the selective introduction of a cold air flow 9 or of a warm air flow 18 into the temperature controlled channel 4, the thermal connection to the heat exchanger 17, may alternatively and/or additionally to the valve 21, also be disconnected, for which a respective valve is arranged inside the heating medium system or, respectively, inside its tubing system 14.

A blowing unit 22, in particular a fan, may be arranged in the inlet 5 of the temperature controlled channel 4, which drives the cold air flow 9 or the warm air flow 18 in the temperature controlled channel 4. Alternatively and/or additionally, blowing units can also be arranged in the nozzles 10 or 19, or in the absorption cooling device 8, and/or in the heat exchanger 17.

The lithium-ion battery system 1 also includes a control unit 24 which enables an adjustment of the temperature of the lithium-ion batteries 2. For this purpose, the control unit 24 is connected to all components relevant for controlling the temperature, as in particular to the absorption cooling device 8, to the valve 15, to the valve 21, and to the blower 22. Furthermore, control unit 24 is connected to the heat sources 11 and 12, for example, to be able to asses their respective current state and/or to adjust and/or to control their heat absorption or heat emission. In the illustrated embodiment, the control unit 24 is also connected to the heat exchanger 17. In addition, control unit 24 is connected to temperature sensors 25 in the temperature controlled channel 4 and/or on the lithium-ion batteries 2.

A simulation has shown, that a heat source with 70 to 80° C. can be used, in order to provide a controlled cooling or, respectively, a cooling temperature of 15° C. for the lithium-ion batteries. In this case, the emitted heat of the absorption cooling device is at about 40° C. These are preferred values for the operation of the lithium-ion battery system according to the invention.

1. Battery system (1) for a motor vehicle, comprising at least one battery (2)
wherein, said battery system comprises at least one absorption cooling device (8) which provides useable controlled cooling for cooling at least one battery (2).

2. The battery system (1) according to claim 1, wherein, water is provided as a refrigerant for the absorption cooling device (8).

3. The battery system (1) according to claim 2, characterized in that an ionic fluid is provided as an absorber for the absorption cooling device (8).

4. The battery system (1) according to claim 3, wherein at least one latent heat storage unit (11) is included as a heat source, which provides the driving heat for the absorption cooling device (8).

5. The battery system (1) according to claim 4, wherein at least one component (12), which is exposed to an external energy source, is included as a heat source, providing driving heat for the absorption cooling device (8).

6. The battery system (1) according to claim 5, wherein multiple heat sources (11, 12) are included, each providing driving heat for the absorption cooling device (8), wherein thermal contact between the absorption cooling device (8) and at least one of these components can be interrupted by means of at least one valve (15).

7. The battery system (1) according to claim 6, wherein at least one temperature controlled channel (4) is included, in which the usable controlled cooling of the absorption cooling device (8) can be introduced as a cold air flow (9).

8. The battery system (1) according to claim 7, wherein at least one heat exchanger (17) is included, which provides usable heat to warm the battery (2).

9. The battery system (1) according to claim 8, wherein said heat exchanger (17) is thermally connected with at least one heat source (11, 12), which provides driving heat for the absorption cooling device (8).

10. The battery system (1) according to claim 9, wherein the useable heat to warm up the battery (2) can be introduced as a warm air flow (18) into the temperature controlled channel (4).

11. The battery system (1) according to claim 10, wherein at least one valve (21) is included, to selectively introduce warm air flow (18) or cold air flow (9) into the temperature controlled channel (4).

12. The battery system (1) according to claim 11, wherein at least one blowing unit (22) is included, to drive warm (18) or cold (9) air flow through the tempering channel (4).

13. The battery system (1) according to claim 12, wherein a control unit (24) is included, which allows the control or adjustment of the temperature of the battery (2).
